(19) United States
(12) Patent Application Publication
(10) Pub. No.: US 2009/0165669 A1
(43) Pub. Date: Jul. 2, 2009

(54) Black Dye Ink for Ink-Jet Recording

(75) Inventors: Yuko IWAMURA, Nagoya-shi (JP); Kazuma GOTO, Nagoya-shi (JP)

Correspondence Address: BANNER & WITCOFF, LTD.;ATTORNEYS FOR CLIENT NO. 016689, 1100 13th STREET, N.W., SUITE 1200, WASHINGTON, DC, 20005-4051, US

(73) Assignee: Brother Kogyo Kabushiki Kaisha, Nagoya-shi (JP)

(21) Appl. No.: 12/332,496

(22) Filed: Dec. 11, 2008

(30) Foreign Application Priority Data
Dec. 26, 2007 (JP) 2007-334767

(51) Int. Cl. C09D 11/02

(52) U.S. Cl. 106/31.13

(57) ABSTRACT

A black dye ink for ink-jet recording includes a black dye, a color dye for toning, a water-soluble organic solvent and water. The black dye ink, in a solid-printed portion printed on glossy paper with the black dye ink and having an average optical density of about 0.9 or more and about 1.1 or less, satisfies simultaneously the following inequalities (1) and (2).

ODimax(0)−ODimin(0)≦about 0.20 (1)

ODimax(1)−ODimin(1)≦about 0.20 (2)

In inequalities (1) and (2), ODimax(0) and ODimin(0) are a maximum optical density and a minimum optical density, respectively, of optical densities of yellow, magenta and cyan color components, respectively; and ODimax(1) and ODimin(1) are a maximum optical density and a minimum optical density, respectively, of optical densities of the yellow, magenta and cyan color components, respectively, after a predetermined ozone resistance test is performed on the solid-printed portion printed with the black dye ink.

### CROSS REFERENCE TO RELATED APPLICATION

The present invention claims a priority from Japanese Patent Application No. 2007-334767, which was filed on Dec. 26, 2007, the disclosure of which is herein incorporated by reference in its entirety.

### BACKGROUND

1. Field of the Invention

The present invention relates to a black dye ink for ink-jet recording.

2. Description of the Related Art

Conventionally, black dye inks for ink-jet recording which use a single black dye have been widely used. If a printed object is obtained by black solid-printing with such a black dye ink on glossy paper and the optical densities of its yellow (Y) color component, magenta (M) color component, and cyan (C) color component are measured, the optical densities of the color components are usually different from each other as illustrated in FIG. 3. Thus, a solid-printed object printed with a black dye ink for ink-jet recording which uses only a single black dye has, for example, when the Y color component has a relatively lower optical density as in FIG. 3, a bluish black color.

To obtain a black color which is as close as possible to an achromatic color, a color dye corresponding to the color component with an insufficient optical density in the black dye is added for color toning so that the optical densities of the yellow (Y) color component, the magenta (M) color component, and the cyan (C) color component in a solid-printed object printed with the black ink are roughly the same (refer to FIG. 4). The color balance (balance in the optical densities of the yellow (Y) color component, the magenta (M) color component and the cyan (C) color component in a solid-printed object) of a printed object printed by use of a black dye ink for ink-jet recording which has been toned in this manner will of course be improved.

The dyes of a printed object printed with a black dye ink for ink-jet recording which has been toned as described above may fade due to the ozone in the storage atmosphere, whereby the optical density of the printed object decreases. In such cases, if the color balance is maintained, the fading tends not to be particularly noticeable even when the optical density of the printed object decreases as a whole. In practice, the yellow (Y) color component, the magenta (M) color component and the cyan (C) color component in the black dye ink have the respective different levels of decrease in optical density. Moreover, the color dye for toning itself which is used together to tone the black color also fades. Thus, in the case of a black dye ink for ink-jet recording which has been toned in such a manner described above, not only does the optical density of the printed object after exposure to ozone relight irradiation decrease, but the color balance also is greatly disrupted.

### SUMMARY

It is an object to realize a good color balance before and after fading due to ozone in a printed object printed with a toned black dye ink for ink-jet recording which comprises a black dye, a color dye for toning, a water-soluble organic solvent and water.

The present inventors found that, in a solid-printed portion printed on glossy paper with a toned black dye ink for ink-jet recording such as that described above, when the printed portion is subjected to an ozone resistance test, rather than merely narrowing the difference in optical densities before and after the ozone resistance test, by measuring the optical densities of the yellow (Y) color component, the magenta (M) color component and the cyan (C) color component of the black solid-printed object, and making the difference between the maximum optical density and the minimum optical density of these three components for both before and after the ozone resistance test to be not greater than a certain value, the above object could be achieved.

An aspect of the present invention provides a black dye ink for ink-jet recording comprising a black dye, a color dye for toning, a water-soluble organic solvent and water, wherein

in a solid-printed portion printed on glossy paper with the black dye ink and having an average optical density of about 0.9 or more and about 1.1 or less, the following inequalities (1) and (2) are satisfied simultaneously:

ODimax(0)−ODimin(0)≦about 0.20 (1)

ODimax(1)−ODimin(1)≦about 0.20 (2)

where ODimax(0) and ODimin(0) are a maximum optical density and a minimum optical density, respectively, of ODiy(0), ODim(0) and ODic(0) which are optical densities of yellow, magenta and cyan color components, respectively; and

ODimax(1) and ODimin(1) are a maximum optical density and a minimum optical density, respectively, of ODiy(1), ODim(1) and ODic(1) which are optical densities of the yellow, magenta and cyan color components, respectively, after a predetermined ozone resistance test is performed on the solid-printed portion printed with the black dye ink.

### BRIEF DESCRIPTION OF THE DRAWINGS

FIG. 1 is a diagram of an optical density; (A) in FIG. 1 being a diagram of the optical density for each color component in a solid-printed object printed with a black dye solution in which only a single black dye is used; (B) in FIG. 1 being a diagram of the optical density for each color component in a solid-printed object printed with a black ink in which a yellow dye and a magenta dye are used as color dyes for toning in combination with a black dye; and (c) in FIG. 1 being an explanatory diagram of the optical density of each of the color components after an ozone resistance test of a solid-printed object printed with a black ink in which a yellow dye and a magenta dye are used as color dyes for toning in combination with a black dye;

FIG. 2 is a chart of an absorbance curve of a black dye;

FIG. 3 is an explanatory diagram of the optical density for each color component in a solid-printed object printed with a black dye ink for ink-jet recording with only a single black dye; and

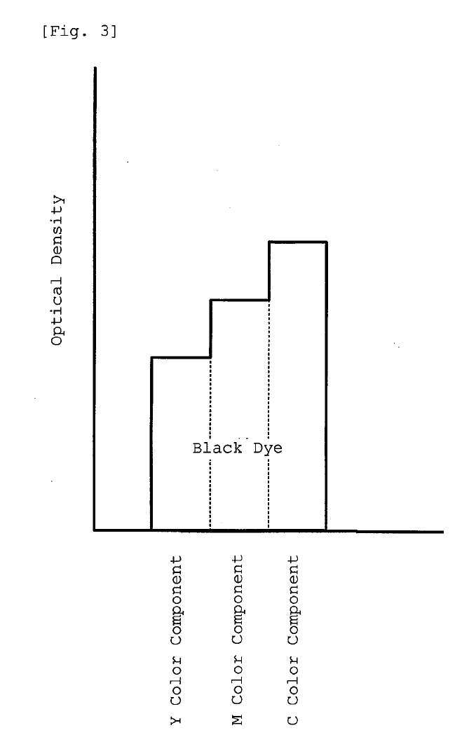

FIG. 4 is an explanatory diagram of the optical density for each color component in a solid-printed object printed with an ink in which a yellow dye and a magenta dye are used as color dyes for toning in combination with a black dye.

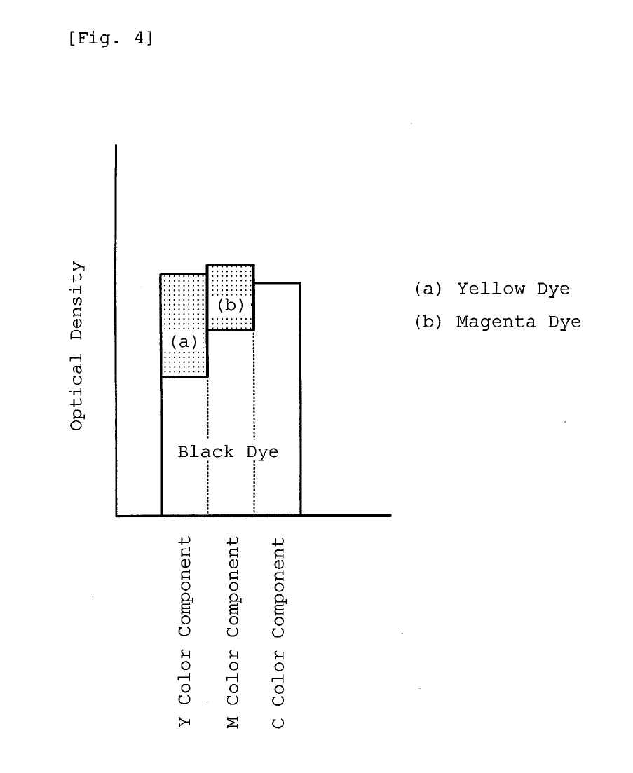

### DETAILED DESCRIPTION OF THE PREFERRED EMBODIMENTS

The black dye ink for ink-jet recording comprises a black dye, a color dye for toning, a water-soluble organic solvent and water, and is characterized by simultaneously satisfying the following formulae (1) and (2).

ODimax(0)−ODimin(0)≦about 0.20 (1)

ODimax(1)−ODimin(1)≦about 0.20 (2)

In the formulae (1) and (2), ODimax(0), ODimin(0), ODimax(1) and ODimin(1) refer to the below-described optical densities. In a solid-printed portion printed on glossy paper with a black dye ink for ink-jet recording and having an average optical density of from about 0.9 or more to about 1.1 or less, the optical density of the Y color component is defined as ODiy(0), the optical density of the M color component is defined as ODim(0) and the optical density of the C color component is defined as ODic(0). The maximum optical density and the minimum optical density of these ODiy(0), ODim(0) and ODic(0) are defined as the maximum optical density ODimax(0) and the minimum optical density ODimin(0), respectively. Furthermore, when a predetermined ozone resistance test is carried out on the solid-printed portion with the black ink, the optical density of the post-test Y color component is defined as ODiy(1), the optical density of the post-test M color component is defined as ODim(1) and the optical density of the post-test C color component is defined as ODic(1). The maximum optical density and the minimum optical density of these ODiy(1), ODim(1) and ODic(1) are defined as the maximum optical density ODimax(1) and the minimum optical density ODimin(1), respectively.

The black dye ink for ink-jet recording has, in a solid-printed portion printed on glossy paper with the black ink, a difference between the maximum optical density and the minimum optical density of the three optical densities of a yellow (Y) color component, a magenta (M) color component, and a cyan (C) color component for both before and after an ozone resistance test, of not greater than about 0.20. Thus, a good color balance for both before and after an ozone resistance test may be realized.

For reference, the definitions of the optical densities in the solid-printed portion printed with the black ink are listed below.

ODiy(0): Initial (pre-test) optical density of the Y color component of the solid-printed portion printed with the black ink

ODim(0): Initial (pre-test) optical density of the M color component of the solid-printed portion printed with the black ink

ODic(0): Initial (pre-test) optical density of the C color component of the black solid-printed portion printed with the black ink

ODimax(0): Initial (pre-test) maximum optical density of the solid-printed portion printed with the black ink

ODimin(0): Initial (pre-test) minimum optical density of the solid-printed portion printed with the black ink

ODiy(1): Post-test optical density of the Y color component of the black solid-printed portion printed with the black ink

ODim(1): Post-test optical density of the M color component of the solid-printed portion printed with the black ink

ODic(1): Post-test optical density of the C color component of the solid-printed portion printed with the black ink

ODimax(1): Post-test maximum optical density of the solid-printed portion printed with the black ink

ODimin(1): Post-test minimum optical density of the solid-printed portion printed with the black ink

The ozone resistance test may be carried out, for example, by leaving the solid-printed portion printed with the black ink or the black dye solution for 40 hours in a chamber having an ozone concentration of 2 ppm at a temperature of 24° C. and a humidity of 60% RH. The test may be carried out by use of the Ozone Weather Meter OMS-H manufactured by Suga Test Instruments Co., Ltd. Measurement of the optical density values may be carried out by use of a Spectrolino (light source: D₆₅, viewing angle: 2°, status A) manufactured by Gretag Macbeth GmbH. Here, “status A” refers to the spectral sensitivity characteristic according to ISO 5/3.

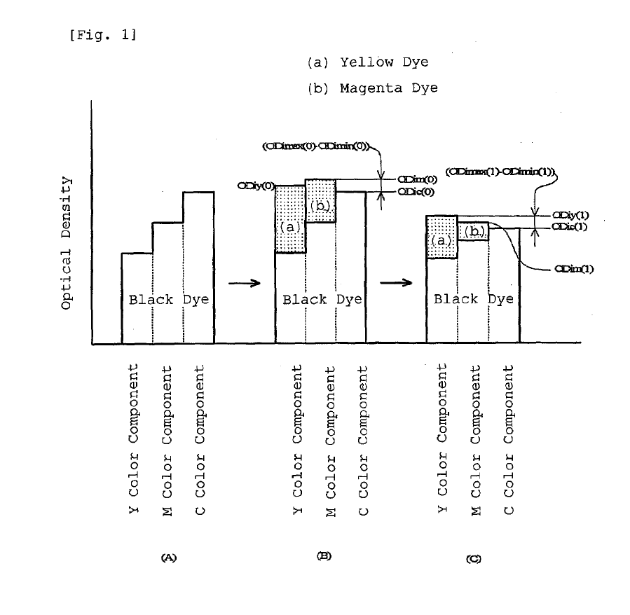

The mutual relationship of ODimax(0), ODimin(0), ODimax(1) and ODimin(1) is shown in FIG. 1. (A) in FIG. 1 is an explanatory diagram of the optical densities of the Y color component, the M color component and the C color component for a printed object printed on the glossy paper by use of a black dye solution in which only a single black dye was used as the coloring agent. In the optical density of the printed object, the Y color component is highly insufficient with respect to the C color component, and the M color component is insufficient with respect to the C color component. This printed object represents a bluish black color. The term “glossy paper” refers to a sheet of paper in which a coated layer for imparting surface smoothness is provided on a base paper. The reason for using a glossy paper is that vivid color development may be obtained with little bleeding of the ink when printed. Examples of the glossy paper include, without any limitations, the photo glossy paper BP61GLA manufactured by Brother Industries, Ltd., the premium photo glossy paper of color ink-jet manufactured by Oji Paper Co., Ltd., the high fineness photo output ultra glossy paper for ink-jet printer manufactured by Kokuyo Co., Ltd., the Photo-like QP “Photo Quality” series manufactured by Konica Minolta Holdings Inc., the Kassai® series photo finishing Pro, Photo Finishing Advance, and Fuji Film premium glossy paper manufactured by Fuji Film Corporation, and the like. Because an optical density value of around 1.0 may be considered to cover the light to dark concentrations of the printed object, the solid-printed portion printed with the black ink utilizes a portion where the initial (pre-test) average optical density (ODiy(0)+ODim(0)+ODic(0)/3) is in the range of from about 0.9 or more to about 1.1 or less. This portion where the initial (pre-test) average optical density is about 0.9 or more and about 1.1 or less may be obtained by toning the gradation and the like of the solid-printed object.

Next, as illustrated in (B) in FIG. 1, a yellow dye and a magenta dye as color dyes for toning are combined with a black dye, and the optical densities of the Y color component and the M color component are made to be the same level as the optical density of the C color component, which has the highest optical density. As a result, the color balance of the printed object before the ozone resistance test is improved. The difference between any two of ODiy(0), ODim(0) and ODic(0) must be not greater than about 0.20. If the difference is more than about 0.20, the color balance deteriorates to an impermissible level. In the case of (B) in FIG. 1, the optical density ODim(0) of the M color component is the ODimax(0), and the optical density ODic(0) of the C color component is the ODimin(0).

Furthermore, even if the solid-printed portion printed with the black ink is subjected to a predetermined ozone resistance test, as illustrated in (C) in FIG. 1, the difference between any two of ODiy(1), ODim(1), and ODic(1) must be not greater than about 0.20. If the difference is more than about 0.20, the color balance deteriorates to an impermissible level. In the case of (C) in FIG. 1, the optical density ODiy(1) of the Y color component is the ODimax(1), and the optical density ODic(1) of the C color component is the ODimin(1).

To determine a preferred black dye for use in the black dye ink for ink-jet recording, first a solid-printed portion is prepared on a glossy paper by use of a black dye solution comprising a black dye, a water-soluble organic solvent and water, which are the essential components of the black dye ink for ink-jet recording excluding a color dye for toning. For this solid-printed portion printed with the black dye solution before test, the optical density of a Y color component is defined as ODdy(0), the optical density of a M color component is defined as ODdm(0), and the optical density of a C color component is defined as ODdc(0), and a maximum optical density of ODdy(0), ODdm(0), and ODdc(0) is defined as ODdmax(0). After this solid-printed portion printed with the black dye solution is subjected to a predetermined ozone resistance test, the post-test optical density of the Y color component is defined as ODdy(1), the post-test optical density of the M color component is defined as ODdm(1) and the post-test optical density of the C color component is defined as ODdc(1). Furthermore, a maximum optical density difference of ΔODdy, ΔODdm and ΔODdc defined by the following formulae (3) to (5) is defined as ΔODdmax. In this case, it is preferred to use a black dye constituting the black dye solution in which the color component exhibiting ΔODdmax matches the color component exhibiting ODdmax(0). Such a black dye is considered to be a black dye in which, of the Y, M and C color components thereof, a color component having the highest optical density before the ozone resistance test is the most likely to fade. As a result, the color balance after fading may be improved. In other words, if the color component which has the highest optical density before the ozone resistance test is the most unlikely to fade, this means that the optical density of that color component after the ozone resistance test is relatively substantially higher than the optical densities of the other color components, which makes it more difficult to maintain the color balance. Furthermore, because the black dyes used in the black dye ink for ink-jet recording often have a cyan hue, the color component exhibiting ΔODdmax preferably has a large rate of decrease in the optical density of the C component.

It is preferred that the black dye solution is obtained by, for example, uniformly mixing a composition which excludes the color dye for toning from the composition of the black dye ink for ink-jet recording. In such case, an amount, equivalent to the excluded color dye for toning, of water, a water-soluble organic solvent, or a mixed solvent thereof may be added to the black dye solution. As a result, an evaluation test may be carried out without causing a large change in the concentration of the black dye from the black dye ink for ink-jet recording. Furthermore, when selecting the solid-printed portion printed with the black dye solution, it is preferred to select a solid-printed portion printed with a black dye solution in which the optical density of the color component exhibiting the highest optical density of the Y color component, the M color component, and the C color component is about 0.9 or more and about 1.1 or less. As a result, the comparison with the evaluation test of the black dye ink for ink-jet recording becomes easy. If the optical density of the color component exhibiting the highest optical density is less than about 0.9, the solid-printed portion printed with the black dye solution may be toned in such a manner that the black dye concentration may be increased so that the optical density is about 0.9 or more and about 1.1 or less, the printing color tone may be toned and the like.

ΔODdy=ODdy(0)−ODdy(1) (3)

ΔODdm=ODdm(0)−ODdm(1) (4)

ΔODdc=ODdc(0)−ODdc(1) (5)

For reference, the definitions of the optical densities in the solid-printed portion printed with the black dye solution are listed below.

ODdy(0): Initial (pre-test) optical density of the Y color component of the solid-printed portion printed with the black dye solution

ODdm(0): Initial (pre-test) optical density of the M color component of the solid-printed portion printed with the black dye solution

ODdc(0): Initial (pre-test) optical density of the C color component of the solid-printed portion printed with the black dye solution

ODdmax(0): Initial (pre-test) maximum optical density of the solid-printed portion printed with the black dye solution

ODdy(1): Post-test optical density of the Y color component of the solid-printed portion printed with the black dye solution

ODdm(1): Post-test optical density of the M color component of the solid-printed portion printed with the black dye solution

ODdc(1): Post-test optical density of the C color component of the solid-printed portion printed with the black dye solution

ΔODdy: Difference in optical density between before and after the test of the Y color component of the solid-printed portion printed with the black dye solution

ΔODdm: Difference in optical density between before and after the test of the M color component of the solid-printed portion printed with the black dye solution

ΔODdc: Difference in optical density between before and after the test of the C color component of the solid-printed portion printed with the black dye solution

ΔODdmax: Maximum optical density difference in the solid-printed portion printed with the black dye solution

If the amount of the black dye is too small, the formation of a solid image having a sufficient optical density becomes difficult even when the total amount of the black dye and the color dye for toning is a preferable amount in the black dye ink for ink-jet recording. Thus, the amount of the black dye is about 50 wt % or more with respect to the total amount of the black dye and the color dye for toning.

It the C color component of the black dye has the highest optical density, and conversely the Y color component has the lowest optical density, a yellow dye is preferably used as the color dye for toning, while on occasion a magenta dye may be used. Furthermore, yellow and magenta dyes may be used together. Depending on the type of the black dye, the optical density of the C color component may be relatively low. In such cases a cyan dye may be used as the color dye for toning. Furthermore, if the ozone fading of the black dye itself is marked, a yellow dye, a magenta dye, and a cyan dye may be used simultaneously in a well-balanced manner.

The rate of decrease in the optical density of the Y color component Aiy, the rate of decrease in the optical density of the M color component Aim and the rate of decrease in the optical density of the C color component Aic after the ozone resistance test compared with before the ozone resistance test as defined in the following formulae (6) to (8) in the solid-printed portion printed with the black ink are all about 20% or less, and about 15% or less. If the rate of decrease in the optical density for all of the color components is about 20% or less, this means that good ozone resistance is exhibited by each color component, so that a good color balance before the ozone resistance test may be maintained basically as is even after the ozone resistance test.

Aiy=[(ODiy(0)−ODiy(1))/ODiy(0)]×100 (6)

Aim=[(ODim(0)−ODim(1))/ODim(0)]×100 (7)

Aic=[(ODic(0)−ODic(1))/ODic(0)]×100 (8).

For reference, the definitions of the rate of decrease in optical density is listed below.

Aiy: Rate of decrease in the optical density of the Y color component after the ozone resistance test (%)

Aim: Rate of decrease in the optical density of the M color component after the ozone resistance test (%)

Aic: Rate of decrease in the optical density of the C color component after the ozone resistance test (%)

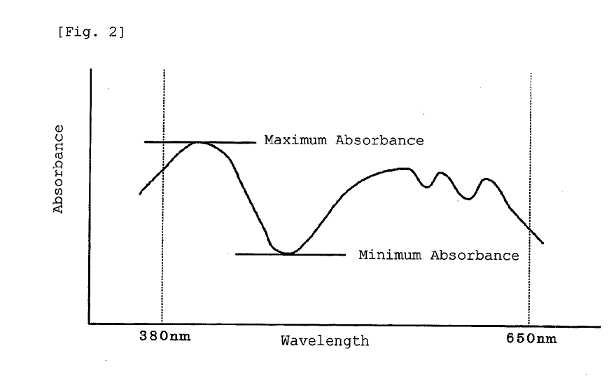

The black dyes which may be used are dyes where, as illustrated in FIG. 2, its minimum absorbance is about 25% or more of the maximum absorbance (maximum peak) when the absorbance of an aqueous solution of the dye is measured across the whole wavelength range of from 380 nm to 650 nm by use of a spectrophotometer (for example, UV-3600 manufactured by Shimadzu Corporation). In such case, the dye concentration of the aqueous solution of the dye is a concentration so that the maximum absorbance is in the range of from about 0.50 to about 1.50.

Examples of black dyes which may be used include, without any limitations, dyes represented by the following general formula (Bk-0), C.I. Acid Blacks 2, 7, 24, 26, 31, 52, 63, 112, 118 and the like; C.I. Direct Blacks 17, 19, 32, 51, 71, 108, 146, 154, 168 and the like; C.I. Basic Black 2; C.I. Food Blacks 1 and 2; and the like.

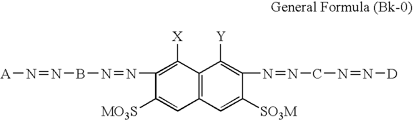

In the general formula (Bk-O), A and D, each independently, represent a substituted or unsubstituted phenyl group, or a substituted or unsubstituted naphthyl group, and B and C, each independently, represent a substituted or unsubstituted naphthyl group. Each of A, B, C and D may comprise one or more sulfo groups. One of X and Y represents a hydroxyl group and the other represents an amino group. M represents a hydrogen atom, an alkali metal, the cation of an organic amino or an ammonium ion. Among the black dyes represented by the general formula (Bk-O), it is preferred to use black dyes represented by the chemical formulae (Bk-1) and (Bk-2), due to the fact that the rate of decrease in optical density is small.

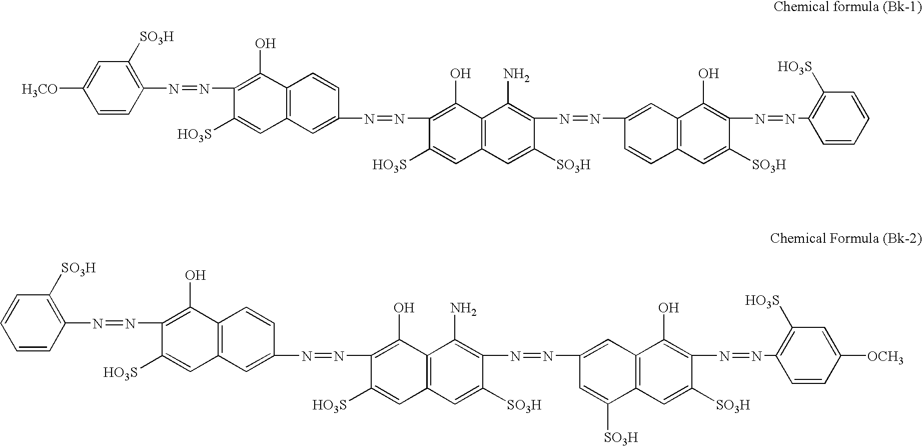

Examples of color dyes for toning which may be used include, without any limitations, yellow dyes such as C.I. Direct Yellows 12, 24, 26, 27, 28, 33, 39, 58, 86, 98, 100, 132, 142, 169 and the like; C.I. Acid Yellows 3, 11, 17, 19, 23, 25, 29, 38, 42, 49, 59, 61, 71, 72 and the like; C.I. Basic Yellow 40 and the like; C.I. Reactive Yellow 2 and the like; and the like; magenta dyes such as dyes represented by the following general formulae (M-0) and (M-00), C.I. Direct Reds 4, 17, 28, 37, 63, 75, 79, 80, 81, 83, 254 and the like; C.I. Acid Reds 1, 6, 8, 18, 32, 35, 37, 42, 52, 85, 88, 115, 133, 134, 154, 186, 249, 289, 407 and the like; C.I. Basic Reds 9, 12, 13 and the like; and C.I. Reactive Reds 4, 23, 24, 31, 56 and the like; and the like; cyan dyes such as C.I. Direct Blues 1, 6, 8, 15, 22, 25, 71, 76, 80, 86, 87, 90, 106, 108, 123, 163, 165, 199, 226 and the like; C.I. Acid Blues 9, 22, 29, 40, 59, 62, 93, 102, 104, 112, 113, 117, 120, 167, 175, 183, 229, 234 and the like; C.I. Basic Blues 1, 3, 5, 7, 9, 24, 25, 26, 28, 29 and the like; and C.I. Reactive Blues 7, 13, 49 and the like; and the like.

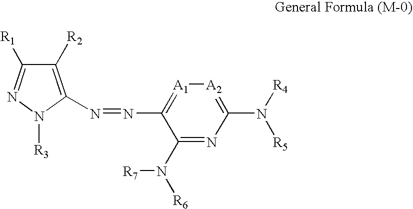

In the general formula (M-0), R₁ represents a hydrogen atom, a substituted or unsubstituted alkyl group or a substituted or unsubstituted aryl group. R₂ represents a hydrogen atom, a halogen atom or a cyano group. R₃ represents a hydrogen atom, a substituted or unsubstituted alkyl group, a substituted or unsubstituted aryl group or a substituted or unsubstituted heterocyclic group. R₄, R₅, R₆ and R₇, each independently, represent a hydrogen atom, a substituted or unsubstituted alkyl group, a substituted or unsubstituted aryl group, a substituted or unsubstituted heterocyclic group, a substituted or unsubstituted sulfonyl group or a substituted or unsubstituted acyl group. However, R₄ and R₅ may not both be a hydrogen atom, and R₆ and R₇ may not both be a hydrogen atom. A₁ and A₂ are either both substituted or unsubstituted carbon atoms, or one of A₁ and A₂ is a substituted or unsubstituted carbon atom and the other is a nitrogen atom.

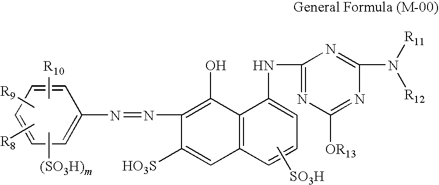

In the general formula (M-00), R₈, R₉ and R₁₀ each independently represent a substituted or unsubstituted alkyl group, a substituted or unsubstituted alkoxy group, a halogen atom, a hydrogen atom, a hydroxyl group, a substituted or unsubstituted carbamoyl group, a substituted or unsubstituted sulfamoyl group, a substituted or unsubstituted amino group, a nitro group, a sulfonate group, a substituted or unsubstituted alkylsulfonyl group, a substituted or unsubstituted arylsulfonyl group, a carboxyl group or a carboxylate group. m represents an integer of 0, 1 or 2. R₁₁, R₁₂ and R₁₃, each independently, represent a hydrogen atom, a substituted or unsubstituted alkyl group, a substituted or unsubstituted alkenyl group, a substituted or unsubstituted aryl group, a substituted or unsubstituted aralkyl group, a substituted or unsubstituted aliphatic group or a substituted or unsubstituted heterocyclic group.

Among the magenta dyes represented by the general formulae (M-0) and (M-00), it is preferred to use a magenta dye represented by the chemical formulae (M-1) to (M-7) due to the fact that its rate of decrease in optical density is small.

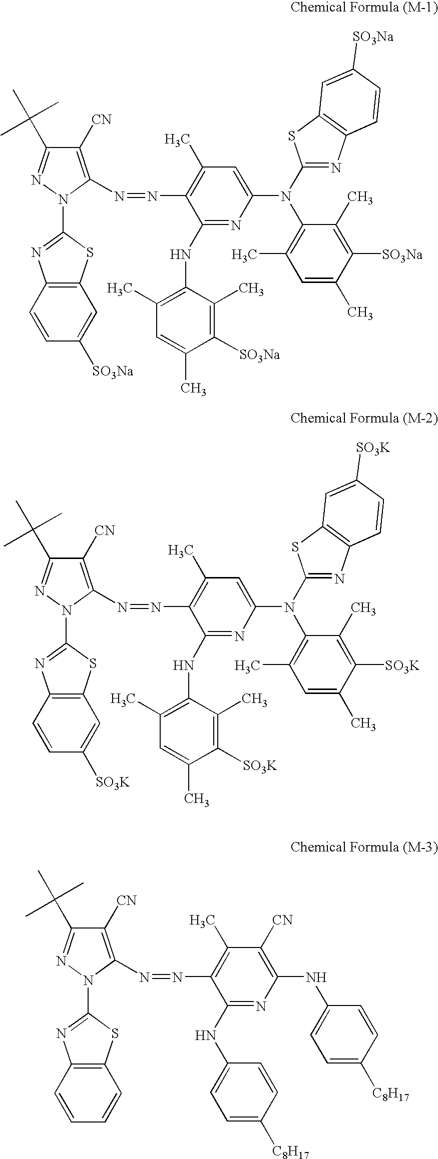

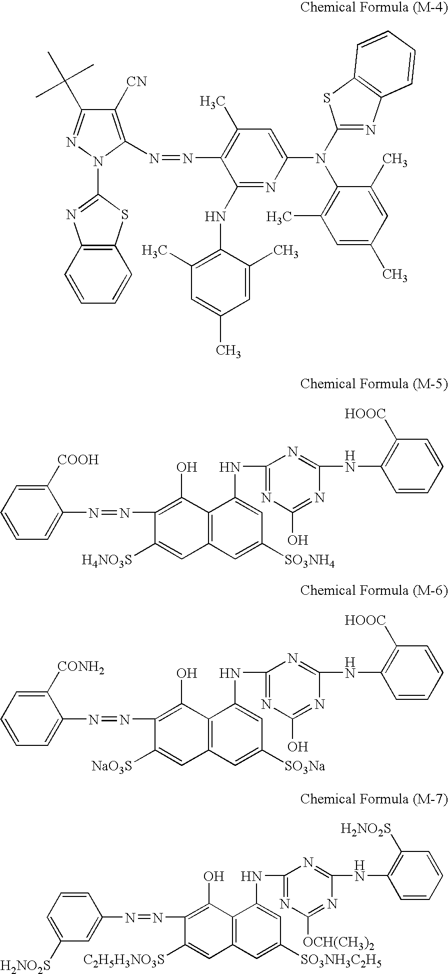

The black dye ink for ink-jet recording comprises, in addition to a black dye and a color dye for toning, as a solvent, water and a water-soluble organic solvent.

Deionized water is used. The amount of water depends on the type of the water-soluble organic solvent used, the composition of the ink and the desired characteristics of the ink and is determined over a wide range. The amount of water, with respect to the total amount of the black dye ink for ink-jet recording, is in the range of from about 10 wt % to about 95 wt %, in the range of from about 10 wt % to about 80 wt %, and in the range of from about 20 wt % to about 80 wt %.

Water-soluble organic solvents may be mainly classified into a humectant and a penetrant, for example. The humectant is added to the ink to prevent the ink from drying at the end portions of nozzles of an ink-jet recording head. The penetrant is added to the ink to increase the drying speed on the recording material surface. Examples of the humectant include, without any limitations, lower alcohols such as methyl alcohol, ethyl alcohol, n-propyl alcohol, isopropyl alcohol, n-butyl alcohol, sec-butyl alcohol and tert-butyl alcohol; amides such as dimethylformamide and dimethylacetamide; ketones and keto-alcohols such as acetone and diacetone alcohol; ethers such as tetrahydrofuran and dioxane; polyalkylene glycols such as polyethylene glycol and polypropylene glycol; alkylene glycols such as ethylene glycol, propylene glycol, butyleneglycol, diethylene glycol, triethylene glycol, dipropylene glycol, tripropylene glycol, thiodiglycol and hexyleneglycol; glycerin; 2-pyrrolidone; N-methyl-2-pyrrolidone; 1,3-dimethyl-2-imidazolidinone; and the like. Of them, polyols such as alkylene glycol, glycerin and the like are preferred.

The amount of the humectant, with respect to the total amount of the black dye ink for ink-jet recording, is in the range of from about 0 wt % to about 95 wt %, in the range of from about 5 wt % to about 80 wt %, and in the range of from about 5 wt % to about 50 wt %.

Examples of the penetrant include, without any limitations, glycol ethers such as ethylene glycol methyl ether, ethylene glycol ethyl ether, ethylene glycol propyl ether, diethylene glycol methyl ether, diethylene glycol ethyl ether, diethylene glycol propyl ether, diethylene glycol butyl ether, triethylene glycol methyl ether, triethylene glycol ethyl ether, triethylene glycol propyl ether, triethylene glycol butyl ether, propylene glycol methyl ether, propylene glycol ethyl ether, propylene glycol propyl ether, propylene glycol butyl ether, dipropylene glycol methyl ether, dipropylene glycol ethyl ether, dipropylene glycol propyl ether, dipropylene glycol butyl ether, tripropylene glycol methyl ether, tripropylene glycol ethyl ether, tripropylene glycol propyl ether, tripropylene glycol butyl ether and the like.

When the amount of the penetrant is too large, the penetrability becomes excessively high, and blurring tends to occur. The amount of the penetrant, with respect to the total amount of the black dye ink for ink-jet recording, is in the range of from about 0 wt % to about 20 wt %, in the range of from about 0.1 wt % to about 15 wt %, and in the range of from about 0.2 wt % to about 10 wt %.

The black dye ink for ink-jet recording may optionally further comprise a conventional, well-known additive, such as a viscosity modifier, for example, polyvinyl alcohol, polyvinylpyrolidone, and a water-soluble resin; a surface tension modifier; an antifungal agent; a pH modifier; and the like.

The black dye ink for ink-jet recording may be prepared by uniformly mixing the black dye and the color dye for toning with the other additive components, such as water, a water-soluble organic solvent and the like, and then removing insoluble matter with a filter.

The black dye ink for ink-jet recording may be used for ink-jet recording by filling into the ink cartridge of a conventional, well-known ink-jet printer.

### EXAMPLES

### 1) Preparation of Black Inks and Black Dye Solutions

### 1-1) Examples 1 to 7 and Comparative Examples 1 to 8

After mixing and stirring the ink compositions of Table 1, the toned black dye inks for ink-jet recording of Examples 1 to 7 and Comparative Examples 1 to 8 were obtained by filtering the mixtures with a hydrophilic PTFE (polytetrafluoroethylene) type membrane filter (pore diameter of 0.2 μm) manufactured by Toyo Roshi Kaisha Ltd. In the ink compositions of Table 1, the black dyes (Bk-1) and (Bk-2) are compounds represented by the chemical formulae (Bk-1) and (Bk-2), respectively, and magenta dyes (M-1) to (M-7) are compounds represented by the chemical formulae (M-1) to (M-7), respectively.

TABLE 1

| | Example | | | | | | | Comparative Example | | | | | | | |
|---|---|---|---|---|---|---|---|---|---|---|---|---|---|---|---|
| | 1 | 2 | 3 | 4 | 5 | 6 | 7 | 1 | 2 | 3 | 4 | 5 | 6 | 7 | 8 |
| Black dye (Bk-1) | 2.78 | — | 3.01 | — | 2.84 | — | — | 2.84 | — | — | — | — | — | — | — |
| Black dye (Bk-2) | — | 2.81 | — | 3.21 | — | — | — | — | 2.50 | — | — | — | — | — | — |
| C.I. Acid Black 24 (AB24) | — | — | — | — | — | — | — | — | — | — | 4.69 | — | — | — | — |
| C.I. Direct Black 19 (DB19) | — | — | — | — | — | 4.71 | — | — | — | 4.67 | — | — | — | — | — |
| C.I. Direct Black 154 | — | — | — | — | — | — | 4.45 | — | — | — | — | — | — | — | 4.47 |
| (DB154) | | | | | | | | | | | | | | | |
| C.I. Food Black 2 (FB2) | — | — | — | — | — | — | — | — | — | — | — | 3.93 | 4.08 | 3.52 | — |
| C.I. Acid Yellow 23 (AY23) | — | — | — | — | — | — | — | 1.14 | — | — | — | — | 0.32 | — | — |
| C.I. Direct Yellow 132 | 1.11 | 1.13 | 0.90 | — | — | 0.13 | 0.24 | — | — | — | 0.24 | — | — | 1.01 | — |
| (DY132) | | | | | | | | | | | | | | | |
| C.I. Direct Yellow 86 (DY86) | — | — | — | — | 1.14 | — | — | — | 1.00 | 0.08 | — | 0.52 | — | — | 0.15 |
| C.I. Direct Yellow 169 | — | — | — | 0.64 | — | — | — | — | — | — | — | — | — | — | — |
| (DY169) | | | | | | | | | | | | | | | |
| Magenta dye (M-1) | 1.11 | — | — | — | — | — | — | 1.02 | — | 0.25 | — | — | — | — | — |
| Magenta dye (M-2) | — | 0.83 | — | — | — | — | — | — | 1.50 | — | — | — | — | — | — |
| Magenta dye (M-3) | — | — | — | 1.15 | 1.02 | — | — | — | — | — | — | — | — | — | 0.38 |
| Magenta dye (M-4) | — | — | — | — | — | — | — | — | — | — | — | 0.55 | — | — | — |
| Magenta dye (M-5) | — | 0.23 | — | — | — | 0.16 | — | — | — | — | — | — | 0.60 | — | — |
| Magenta dye (M-6) | — | — | 1.09 | — | — | — | — | — | — | — | — | — | — | 0.47 | — |
| Magenta dye (M-7) | — | — | — | — | — | — | 0.31 | — | — | — | 0.07 | — | — | — | — |
| Glycerin | 35.0 | 35.0 | 35.0 | 35.0 | 35.0 | 35.0 | 35.0 | 35.0 | 35.0 | 35.0 | 35.0 | 35.0 | 35.0 | 35.0 | 35.0 |
| Triethylene glycol butyl ether | 4.0 | 4.0 | 4.0 | 4.0 | 4.0 | 4.0 | 4.0 | 4.0 | 4.0 | 4.0 | 4.0 | 4.0 | 4.0 | 4.0 | 4.0 |
| Surfactant *1 | 0.06 | 0.06 | 0.06 | 0.06 | 0.06 | 0.06 | 0.06 | 0.06 | 0.06 | 0.06 | 0.06 | 0.06 | 0.06 | 0.06 | 0.06 |
| Water | Balance | | | | | | | Balance | | | | | | | |
| Total amount of coloring | 5.00 | 5.00 | 5.00 | 5.00 | 5.00 | 5.00 | 5.00 | 5.00 | 5.00 | 5.00 | 5.00 | 5.00 | 5.00 | 5.00 | 5.00 |
| agent in the ink (wt %) | | | | | | | | | | | | | | | |
| Dye weight ratio | 56/44 | 56/44 | 60/40 | 64/36 | 57/43 | 94/6 | 89/11 | 57/43 | 50/50 | 93/7 | 94/6 | 79/21 | 82/18 | 70/30 | 89/11 |
| (Black dye/Color dye) | | | | | | | | | | | | | | | |

*1 Polyoxyethylenealkyl(12,13) ether sodium sulfate (3E.O)

### 1-2) Black Dye Solutions 1 to 4

Black dye solutions 1 to 4 having the black dye solution compositions of Table 2 were obtained by carrying out the same operations as in Examples and Comparative Examples described above, except that a color dye for toning was not used. However, the increase/decrease in the blended amount of the black dye and the blended amount of the not-used color dye for toning were made up with water. Furthermore, in the black dye solution compositions of Table 2, the black dyes (Bk-1) and (Bk-2) are compounds represented by the chemical formulae (Bk-1) and (Bk-2), respectively.

TABLE 2

| | | | Black dye solution | | | |
|---|---|---|---|---|---|---|
| | | | 1 | 2 | 3 | 4 |
| Black dye | Black dye | Black dye (Bk-1) | 2.78 | — | — | — |
| solution | | Black dye (Bk-2) | — | 2.81 | — | — |
| composition | | C.I. Direct Black 19 (DB19) | — | — | 4.71 | — |
| (wt %) | | C.I. Direct Black 154 (DB154) | — | — | — | 4.45 |

| | | | | |
|---|---|---|---|---|
| Glycerin | 35.0 | 35.0 | 35.0 | 35.0 |
| Triethylene glycol butyl ether | 4.0 | 4.0 | 4.0 | 4.0 |
| Surfactant *1 | 0.06 | 0.06 | 0.06 | 0.06 |
| Water | Balance | Balance | Balance | Balance |

| | | | | | |
|---|---|---|---|---|---|
| Optical density before | Y component (ODdy(0)) | 0.78 | 0.76 | 0.81 | 0.88 |
| ozone resistance test | M component (ODdm(0)) | 1.09 | 1.07 | 0.98 | 0.88 |
| | C component (ODdc(0)) | 1.26 | 1.24 | 1.17 | 1.14 |
| | ODdmax(0) component | C component | C component | C component | C component |
| Optical density after | Y component (ODdy(1)) | 0.74 | 0.72 | 0.44 | 0.37 |
| ozone resistance test | M component (ODdm(1)) | 1.00 | 0.98 | 0.41 | 0.29 |
| | C component (ODdc(1)) | 1.07 | 1.05 | 0.37 | 0.29 |
| Difference in optical | Y component (ΔODdy) | 0.04 | 0.04 | 0.37 | 0.51 |
| density before the ozone | M component (ΔODdm) | 0.09 | 0.09 | 0.57 | 0.59 |
| resistance test | C component (ΔODdc) | 0.19 | 0.19 | 0.80 | 0.85 |
| | ΔODdmax component | C component | C component | C component | C component |

*1 Polyoxyethylenealkyl(12,13) ether sodium sulfate (3E.O)

### 2) Printing of Evaluation Sample

Each of the black inks and black dye solutions prepared in the above 1) was filled into an ink cartridge. These cartridges were mounted onto a digital multifunction device equipped with an ink-jet printer (DCP-115, product of Brother Industries, Ltd.). Then, a 16-gray scale gradation sample (black to gray to white) was solid-printed on a photo glossy paper BP61GLA manufactured by Brother Industries, Ltd.

### 3) Evaluation of Black Inks

### 3-1) Optical Density Measurement of Each Color Component Before the Ozone Resistance Test

From the evaluation sample (gradation sample) printed in the above 2), a black printed portion printed with a black ink, having an average optical density for the Y color component, the M color component and the C color component of 0.9 or more and 1.1 or less, was selected as an evaluation sample. The initial (pre-test) optical densities of the Y color component, the M color component and the C color component (ODiy(0), ODim(0) and ODic(0)) were measured by use of a Spectrolino (light source: D₆₅, viewing angle: 2°, status A) manufactured by GretagMacbeth GmbH. The obtained results are summarized in Table 3.

Furthermore, from the initial (pre-test) optical densities of the Y color component, the M color component and the C color component, ODimax(0) and ODimin(0) were specified, and then evaluation was carried out according to the following evaluation criteria. The obtained results are summarized in Table 3.

ODimax(0)−ODimin(0)≦0.20 A

0.20<ODimax(0)−ODimin(0)≦0.25 B

0.25<ODimax(0)−ODimin(0) C

### 3-2) Optical Density Measurement of Each Color Component After the Ozone Resistance Test

An ozone resistance test was carried out on the evaluation sample used in the above 3-1) by use of the Ozone Weather Meter OMS-H manufactured by Suga Test Instruments Co., Ltd. Specifically, the evaluation sample was left for 40 hours in a chamber having an ozone concentration of 2 ppm at a temperature of 24° C. and a humidity of 60% RH. After the ozone resistance test, the post-test optical densities of the Y color component, the M color component and the C color component (ODiy(1), ODim(1) and ODic(1)) were measured by use of a Spectrolino (light source: D₆₅, viewing angle: 2°, status A) manufactured by GretagMacbeth GmbH. The obtained results are summarized in Table 3.

Furthermore, from the post-test optical densities of the Y color component, the M color component and the C color component, ODimax(1) and ODimin(1) were specified, and evaluation was carried out according to the following evaluation criteria. The obtained results are summarized in Table 3.

ODimax(1)−ODimin(1)≦0.20 A

0.20<ODimax(1)−ODimin(1)≦0.25 B

0.25<ODimax(1)−ODimin(1) C

### 3-3) Rate of Decrease in Optical Density of Each Color Component after the Ozone Resistance Test

The rate of decrease in the optical densities of the Y color component, the M color component and the C color component (Aiy, Aim and Aic) was determined from the above initial (pre-test) optical densities as determined by the method of 3-1) and the post-test optical densities as determined by the method of 3-2). The obtained results are summarized in Table 3.

### 3-4) Overall Evaluation

The black inks of Examples 1 to 7 and Comparative Examples 1 to 8 were evaluated according to the following evaluation criteria. The obtained results are summarized in Table 3.

Excellent: The above 3-1) and 3-2) evaluations are both “A,” and all of Aiy, Aim and Aic are 20% or less.
Very Good The above 3-1) and 3-2) evaluations are both “A,” and all of Aiy, Aim and Aic are above 20% but not greater than 25%.
Good: The above 3-1) and 3-2) evaluations are both “A,” but any one of Aiy, Aim and Aic is more than 25%.
Not Good Either of the above 3-1) and 3-2) evaluations are “B” or “C”.

TABLE 3

| | | | Example | | | | | | |
|---|---|---|---|---|---|---|---|---|---|
| | | | 1 | 2 | 3 | 4 | 5 | 6 | 7 |
| Composition | Coloring agent in black | | Bk-1 | Bk-2 | Bk-1 | Bk-2 | Bk-1 | DB19 | DB154 |
| | ink | | DY132 | DY132 | DY132 | DY169 | DY86 | DY132 | DY132 |
| | | | M-1 | M-2, M-5 | M-6 | M-3 | M-3 | M-5 | M-7 |
| | Dye weight ratio | | 56/44 | 56/44 | 60/40 | 64/36 | 57/43 | 96/4 | 88/12 |
| | (Black dye/Color dye) | | | | | | | | |
| Before ozone | OD | Y component | 1.01 | 1.03 | 0.95 | 0.99 | 0.96 | 0.81 | 0.87 |
| resistance test | | (ODiy(0)) | | | | | | | |
| | | M component | 1.06 | 1.08 | 0.97 | 1.00 | 1.03 | 0.90 | 0.94 |
| | | (ODim(0)) | | | | | | | |
| | | C component | 1.00 | 1.03 | 1.00 | 0.99 | 1.02 | 1.00 | 1.05 |
| | | (ODic(0)) | | | | | | | |
| | ODimax(0) − ODimin(0) | | 0.06 | 0.05 | 0.05 | 0.01 | 0.07 | 0.19 | 0.18 |
| | Evaluation | | A | A | A | A | A | A | A |
| After ozone | OD | Y component | 0.96 | 0.98 | 0.84 | 0.91 | 0.90 | 0.52 | 0.40 |
| resistance test | | (ODiy(1)) | | | | | | | |
| | | M component | 0.95 | 0.93 | 0.76 | 0.89 | 0.93 | 0.44 | 0.32 |
| | | (ODim(1)) | | | | | | | |
| | | C component | 0.81 | 0.83 | 0.78 | 0.78 | 0.81 | 0.37 | 0.27 |
| | | (ODic(1)) | | | | | | | |

| | | | | | | | |
|---|---|---|---|---|---|---|---|
| ODimax(1) − Odimin(1) | 0.15 | 0.15 | 0.08 | 0.13 | 0.12 | 0.15 | 0.13 |
| Evaluation | A | A | A | A | A | A | A |

| | | | | | | | | |
|---|---|---|---|---|---|---|---|---|
| Rate of | Y component | 5.0% | 4.9% | 11.6% | 8.1% | 6.2% | 35.8% | 54.0% |
| decrease in | (Aiy) | | | | | | | |
| OD after | M component | 10.4% | 13.9% | 21.6% | 11.0% | 9.7% | 51.1% | 66.0% |
| ozone | (Aim) | | | | | | | |
| resistance | C component | 19.0% | 19.4% | 22.0% | 21.2% | 20.6% | 63.0% | 74.3% |
| test | (Aic) | | | | | | | |

| | | | | | | | |
|---|---|---|---|---|---|---|---|
| Overall evaluation | Excellent | Excellent | Very | Very | Very | Good | Good |
| | | | Good | Good | Good | | |

| | | | Comparative Example | | | | | | | |
|---|---|---|---|---|---|---|---|---|---|---|
| | | | 1 | 2 | 3 | 4 | 5 | 6 | 7 | 8 |
| Composition | Coloring agent in | | Bk-1 | Bk-2 | DB19 | AB24 | FB2 | FB2 | FB2 | DB154 |
| | black ink | | AY23 | DY86 | DY86 | DY132 | DY86 | AY23 | DY132 | DY86 |
| | | | M-1 | M-2 | M-1 | M-7 | M-4 | M-5 | M-6 | M-3 |
| | Dye weight ratio | | 57/43 | 50/50 | 93/7 | 94/16 | 79/21 | 82/18 | 70/30 | 89/11 |
| | (Black dye/Color dye) | | | | | | | | | |
| Before ozone | OD | Y component | 0.86 | 0.98 | 0.86 | 0.96 | 1.01 | 0.94 | 0.96 | 0.92 |
| resistance test | | (ODiy(0)) | | | | | | | | |
| | | M component | 0.98 | 1.14 | 0.90 | 0.98 | 1.02 | 1.04 | 1.04 | 0.94 |
| | | (ODim(0)) | | | | | | | | |
| | | C component | 0.97 | 1.00 | 1.00 | 0.98 | 0.98 | 0.98 | 0.99 | 1.05 |
| | | (ODic(0)) | | | | | | | | |
| | ODimax(0) − | | 0.12 | 0.16 | 0.14 | 0.02 | 0.04 | 0.10 | 0.08 | 0.13 |
| | ODimin(0) | | | | | | | | | |
| | Evaluation | | A | A | A | A | A | A | A | A |
| After ozone | OD | Y component | 0.64 | 0.91 | 0.60 | 0.54 | 0.67 | 0.47 | 0.58 | 0.60 |
| resistance test | | (ODiy(1)) | | | | | | | | |
| | | M component | 0.87 | 1.03 | 0.44 | 0.20 | 0.56 | 0.39 | 0.41 | 0.32 |
| | | (ODim(1)) | | | | | | | | |
| | | C component | 0.75 | 0.78 | 0.37 | 0.07 | 0.15 | 0.12 | 0.13 | 0.27 |
| | | (ODic(1)) | | | | | | | | |

| | | | | | | | | |
|---|---|---|---|---|---|---|---|---|
| ODimax(1) − | 0.23 | 0.25 | 0.23 | 0.47 | 0.52 | 0.35 | 0.45 | 0.33 |
| Odimin(1) | | | | | | | | |
| Evaluation | B | B | B | C | C | C | C | C |

| | | | | | | | | | |
|---|---|---|---|---|---|---|---|---|---|
| Rate of | Y component | 25.6% | 7.1% | 30.2% | 43.8% | 33.7% | 50.0% | 39.6% | 34.8% |
| decrease in | (Aiy) | | | | | | | | |
| OD after | M component | 11.2% | 9.6% | 51.1% | 79.6% | 45.1% | 62.5% | 60.6% | 66.0% |
| ozone | (Aim) | | | | | | | | |
| resistance | C component | 22.7% | 22.0% | 63.0% | 92.9% | 84.7% | 87.8% | 86.9% | 74.3% |
| test | (Aic) | | | | | | | | |

| | | | | | | | | |
|---|---|---|---|---|---|---|---|---|
| Overall evaluation | Not | Not | Not | Not | Not | Not | Not | Not |
| | Good | Good | Good | Good | Good | Good | Good | Good |

OD: Optical density

### 4) Evaluation of Black Dye Solutions

### 4-1) Optical Density Measurement of Each Color Component Before the Ozone Resistance Test

From the evaluation sample (gradation sample) printed in the above 2), a solid-printed portion printed with a black ink solution having an optical density for any of the Y color component, the M color component, and the C color component of 0.9 or more and 1.1 or less, and having a maximum color component optical density of those, was selected as an evaluation sample. The initial (pre-test) optical densities of the Y color component, the M color component and the C color component (ODdy(0), ODdm(0) and ODdc(0)) were measured by use of a Spectrolino (light source: D₆₅, viewing angle: 2°, status A) manufactured by GretagMacbeth GmbH. The obtained results are summarized in Table 2.

### 4-2) Optical Density Measurement of Each Color Component After the Ozone Resistance Test

An ozone resistance test was carried out on the evaluation sample used in the above 4-1), by use of the Ozone Weather Meter OMS-H manufactured by Suga Test Instruments Co., Ltd. Specifically, the evaluation sample was left for 40 hours in a chamber having an ozone concentration of 2 ppm at a temperature of 24° C. and a humidity of 60% RH. After the ozone resistance test, the post-test optical densities of the Y color component, the M color component and the C color component (ODdy(1), ODdm(1) and ODdc(1)) were measured by use of a Spectrolino (light source: D₆₅, viewing angle: 2°, status A) manufactured by GretagMacbeth GmbH. The obtained results are summarized in Table 2.

### 4-3) Difference in the Optical Density of Each Color Component Before and after the Ozone Resistance Test

The difference in the optical densities of the Y color component, the M color component and the C color component (ΔODdy, ΔODdm and ΔODdc) were determined from the above initial (pre-test) optical densities as determined by the method of 4-1) and the post-test optical densities as determined by the method of 4-2). The obtained results are summarized in Table 2.

### (Consideration)

In Examples 1 to 7 and Comparative Examples 1 to 8, because the color component having the maximum optical density (OD value) in the used black dyes was always the C color component, a yellow dye and a magenta dye as color dyes for toning were used together with the black dye.

For Examples 1 and 2, the difference between the maximum optical density and the minimum optical density in each of the color components both before and after the ozone resistance test on the evaluation sample was 0.20 or less, meaning that the color balance before and after the ozone resistance test was good. Furthermore, the rate of decrease in optical density for each of the color components due to the ozone resistance test was 20% or less, meaning that ozone resistance was also very good.

For Examples 3 to 5, the difference between the maximum optical density and the minimum optical density in each of the color components both before and after the ozone resistance test on the evaluation sample was 0.20 or less, meaning that the color balance before and after the ozone resistance test was good. However, because the rate of decrease in optical density for each cyan color component due to the ozone resistance test was slightly more than 20%, ozone resistance was worse than that for Examples 1 and 2, although not a problem in practice.

For Examples 6 and 7, the difference between the maximum optical density and the minimum optical density in each of the color components both before and after the ozone resistance test on the evaluation sample was 0.20 or less, meaning that the color balance before and after the ozone resistance test was good. Moreover, because the rate of decrease in optical density for each of the color components due to the ozone resistance test was much more than 20%, ozone resistance was worse than that for Examples 1 and 2. However, as described above, color balance was not a problem in practice.

For Comparative Examples 1 to 3, the difference between the maximum optical density and the minimum optical density in each of the color components before the ozone resistance test on the evaluation sample was 0.20 or less, meaning that the color balance before the ozone resistance test was good. However, because the difference between the maximum optical density and the minimum optical density after the ozone resistance test was more than 0.20, there was a problem with the color balance after the ozone resistance test.

For Comparative Examples 4 to 8, the difference between the maximum optical density and the minimum optical density in each of the color components before the ozone resistance test on the evaluation sample was 0.20 or less, meaning that the color balance before the ozone resistance test was good. However, because the difference between maximum optical density and minimum optical density after the ozone resistance test was much more than 0.25, there was a big problem with the color balance after the ozone resistance test.

The present invention is not limited to the embodiments described in the Examples, which are provided for illustrative purposes only. The material substances, their amounts used, and the conditions of producing them may be varied and modified without departing from the spirit and the scope of the invention as described herein.

What is claimed is:

1. A black dye ink for ink-jet recording comprising a black dye, a color dye for toning, a water-soluble organic solvent and water, wherein
in a solid-printed portion printed on glossy paper with the black dye ink and having an average optical density of about 0.9 or more and about 1.1 or less, the following inequalities (1) and (2) are satisfied simultaneously:
ODimax(0)−ODimin(0)≦about 0.20 (1)
ODimax(1)−ODimin(1)≦about 0.20 (2)
where ODimax(0) and ODimin(0) are a maximum optical density and a minimum optical density, respectively, of ODiy(0), ODim(0) and ODic(0) which are optical densities of yellow, magenta and cyan color components, respectively; and
ODimax(1) and ODimin(1) are a maximum optical density and a minimum optical density, respectively, of ODiy(1), ODim(1) and ODic(1) which are optical densities of the yellow, magenta and cyan color components, respectively, after a predetermined ozone resistance test is performed on the solid-printed portion printed with the black dye ink.

2. A black dye ink for ink-jet recording according to claim 1, wherein,
in a printed portion which is printed on glossy paper with a black dye solution comprising the black dye, the water-soluble organic solvent and water, removing the color dye for toning from the constitutional components of the black dye ink,
the black dye to be comprised in the black dye ink is a black dye comprised in the black dye solution being such that a color component giving ΔODdmax agrees with a color component giving ODdmax(0), where ODdmax(0) is a maximum optical density of ODdy(0), ODdm(0) and ODdc(0) which are optical densities of the yellow, magenta and cyan color components, respectively, and where ΔODdmax is a maximum optical density difference value of ΔODdy, ΔODdm and ΔODdc defined by the following equations (3) to (5):
ΔODdy=ODdy(0)−ODdy(1) (3)
ΔODdm=ODdm(0)−ODdm(1) (4)
ΔODdc=ODdc(0)−ODdc(1) (5)
where ODdy(1), ODdm(1) and ODdc(1) are optical densities of the yellow, magenta and cyan color components, respectively, after a predetermined ozone resistance test is performed on the solid-printed portion printed with the black dye solution.

3. The black dye ink for ink-jet recording according to claim 2, wherein the color component exhibiting ΔODdmax is a cyan color component.

4. The black dye ink for ink-jet recording according to claim 1, wherein an amount of the black dye is about 50 wt % or more with respect to a total amount of the black dye and the color dye for toning.

5. The black dye ink for ink-jet recording according to claim 1, wherein the color dye for toning is a yellow dye.

6. The black dye ink for ink-jet recording according to claim 1, wherein the color dye for toning is a magenta dye.

7. The black dye ink for ink-jet recording according to claim 1, wherein the color dye for toning comprises a yellow dye and a magenta dye.

8. The black dye ink for ink-jet recording according to claim 1, wherein all of Aiy, Aim and Aic as defined in the following formulae (6) to (8) are about 20% or less:
Aiy=[(ODiy(0)−ODiy(1))/ODiy(0)]×100 (6)
Aim=[(ODim(0)−ODim(1))/ODim(0)]×100 (7)
Aic=[(ODic(0)−ODic(1))/ODic(0)]×100 (8).
